(19) United States
(12) Patent Application Publication
(10) Pub. No.: US 2021/0063061 A1
(43) Pub. Date: Mar. 4, 2021

(54) Thermoelectric Cooling Apparatus

(71) Applicant: Anheuser-Busch InBev S.A., Brussels (BE)

(72) Inventors: Daniel Peirsman, Leuven (BE); Stijn Vandekerckhove, Leuven (BE)

(21) Appl. No.: 16/077,972

(22) PCT Filed: Feb. 9, 2017
(86) PCT No.: PCT/EP2017/052827

§ 371 Date: Aug. 14, 2018

(30) Foreign Application Priority Data
Feb. 15, 2016 (EP) 16155683.2

(51) Int. Cl. F25B 21/02; B67D 1/08

(52) U.S. Cl. CPC F25B 21/02; F25B 2321/023; F25B 2321/021; B67D 1/0869

(57) ABSTRACT

A cooling apparatus including (a) one thermoelectric cooler of the Pelletier type, having a hot surface and a cold surface is disclosed. The apparatus further includes (b) a heat sink thermally connected to the hot surface, and (c) a first and optionally a second heat conductive panels with a contact portion in thermal contact with a first and optionally a second corresponding portions of the cold surface over a first and optionally second contact areas. The contact portions of the first and optionally second heat conductive panels are pressed against the corresponding first and second portions of the cold surface with a first and respectively second contact pressures. A (d) control means controls the average temperature of the heat conductive panel. The control means includes area control means for varying the first and optionally second contact areas, and/or pressure means for controlling the first and optionally second contact pressures.

### TECHNICAL FIELD

The present invention relates to a thermoelectric cooling system characterized by a specific temperature regulation system. The thermoelectric cooling systems of the present invention are particularly suitable for cooling liquids, typically beverages such as beer, malt based beverages, sodas, and the like stored in a container ready for dispensing. In particular, they can be advantageously used to cool two such containers at different temperatures using a single thermoelectric device.

### BACKGROUND FOR THE INVENTION

Many applications require the cooling of a liquid. In particular, beverages must often be cooled prior to or upon dispensing. This is the case of malt based beverages, such as beer, or any soda. Many beverage dispensers comprise a cooled compartment for storing a container. A common cooling system is based on the compression-expansion of a refrigerant gas of the type used in household refrigerators. Alternatively, the container, or the dispensing tube used for dispensing a beverage out of the container may be cooled by contacting them with a cold fluid, such as water. Thermoelectric cooling systems using the Peltier effect have also been proposed in the art for cooling a container stored in a dispensing appliance. Although not as efficient as other cooling systems, thermoelectric cooling systems have the great advantage of not requiring any refrigerant gas, nor any source of cold refrigerant liquid and only require to be plugged to a source of power. Examples of beverage dispensing appliances comprising a thermoelectric cooling system are disclosed in EP1188995. EP2103565, DE1020060053, U.S. Pat. Nos. 6,658,859, 5,634,343, WO2007076584, WO8707361, WO2004051163, EP1642863, etc.

As illustrated in FIG. 1, a thermoelectric device (10) has two opposite surfaces: a cold surface (10C) and a hot surface (10H). When DC current flows through the device, it brings heat from the cold surface to the hot surface, so that the cold surface gets cooler while the hot surface gets hotter. The hot surface (10H) is thermally coupled to a heat sink so that it remains at ambient temperature, while the temperature of the cold surface (10C) drops below room temperature. In some applications, multiple coolers can be cascaded together for lower temperature.

As illustrated in FIG. 1, a thermoelectric device is constituted of one or more pairs of (semi)conductors (10N, 10P) having different Fermi level placed in electric contact with one another by means of electrically conductive bridges (1E). The Fermi level represents the demarcation in energy within the conduction band of a metal, between the energy levels occupied by electrons and those that are unoccupied. Upon application of a DC tension difference between two conductors with different Fermi levels making electrical contact, electrons flow from the conductor with the higher level, until the change in electrostatic potential brings the two Fermi levels to the same value. Current passing across the junction results in either a forward or reverse bias, resulting in a temperature gradient. If the temperature of the hot surface (10H) is kept low by removing the generated heat towards a heat sink, the temperature of the cold surface (10C) can be lowered by tens of degrees.

The thermoelectric semiconductor material most often used in today's thermoelectric coolers is an alloy of Bismuth Telluride (Bi₂Te₃) that has been suitably doped to provide individual blocks or elements having distinct “N” and “P” characteristics (cf. 10N and 10P in FIG. 1). Other thermoelectric materials include Lead Telluride (PbTe), Silicon Germanium (SiGe), and Bismuth-Antimony (Bi—Sb) alloys, which may be used in specific situations; however, Bismuth Telluride is the best material in most cooling devices.

In order to draw heat from an item to be cooled, such as a beverage container towards the cold surface (10C) of the thermoelectric device, a heat conductive panel (21) is thermally coupled to both the item to be cooled (e.g., container) and the cold surface of the thermoelectric device. The amount of heat extracted from the item to be cooled can be controlled by simply varying the intensity of DC current fed to the thermoelectric device, or by extracting less heat from the hot surface. Generally, all thermoelectric devices are controlled by the former method, viz., by controlling the intensity of the DC current.

In some applications, it is desirable to cool more than one item down to different temperatures. For example, in the case of beverage dispensing appliance containing at least two containers containing different beverages which must be served at different temperatures, such as special beers, wines, etc., then one thermoelectric device is generally associated with each container, and the cooling temperature is controlled for each thermoelectric device by controlling the current intensities fed to each individual device. Such appliances are for example disclosed in EP1642863, WO2007076584, U.S. Pat. Nos. 5,634,343, and 6,658,859. Thermoelectric devices are not cheap, and providing one such device per container obviously increases the cost of a multi-container dispensing appliance.

It would be desirable to provide a temperature control system for thermoelectric devices allowing two items to be cooled at different and controlled temperatures with a single thermoelectric device. The present invention proposes a solution meeting such objective. This and other objects of this invention will be evident when viewed in light of the drawings, detailed description, and appended claims.

### SUMMARY OF THE INVENTION

The present invention is defined in the appended independent claims. Preferred embodiments are defined in the dependent claims. In particular, the present invention concerns a cooling apparatus comprising:
(a) Thermoelectric cooling device of the Pelletier type, comprising a hot surface and a cold surface,
(b) A heat sink thermally coupled to the hot surface, and
(c) A first heat conductive panel comprising a contact portion in thermal contact with a first portion of the cold surface (10C) over a first contact area, A1, said contact portion of the first heat conductive panel being pressed against said portion of the cold surface with a first contact pressure, P1,
(d) Control means for controlling the average temperature of the heat conductive panel;
   Characterized in that, the control means comprises area control means for varying the first contact area, A1, and/or pressure means for controlling the first contact pressure, P1.

In a preferred embodiment, the first area control means for varying the first contact area, A1, comprises one of the following:
(a) a rotating knob which rotation drives a translation of the contact portion (21C) of the first heat conductive panel (21) along a given direction parallel to and over the first portion of the cold surface (10C), thus varying the first contact area, A1, wherein the knob is preferably connected to a toothed gear gripping teeth aligned on a surface of the contact portion (21C) of the first heat conductive panel along said given direction of translation; or
(b) a lever allowing the translation of the contact portion (21C) of the first heat conductive panel over the cold surface (10C), by pivoting thereof over a hinge,
   and wherein the first heat conductive panel (21) preferably comprises a flexible portion absorbing any translation of the contact portion of the first heat conductive panel to vary the first contact area, A1.

In order to reduce shear stresses between the contact portion and the cold surface of the thermoelectric cooling device, it is preferred that before the contact portion of the first heat conductive panel is translated over the first portion of the cold surface of the thermoelectric cooling device, the first contact pressure between the contact portion of the first heat conductive panel and the first portion of the cold surface of the thermoelectric cooling devicer is reduced.

The pressure control means for varying the first contact pressure, P1, may comprise one of the following:
(a) a cam able to apply a pressure normal to the contact portion of the first heat conductive panel of varying magnitude;
(b) a solenoid able to apply an electromagnetic force to the contact portion of the first heat conductive panel which comprises a ferromagnetic material;
(c) a bladder able to apply a pressure normal to the contact portion of the first heat conductive panel of varying magnitude upon inflating by injection of pressurized gas into said bladder; or
(d) a screw able to apply a pressure normal to the contact portion of the first heat conductive panel of varying magnitude.

In any of the foregoing pressure control means, it is preferred that, at rest, not the whole surface of the contact portion of the first heat conductive panel is in contact with the cold surface of the thermoelectric cooler and wherein the application of a contact pressure (P1) normal to the contact portion flexes it, thus enhancing thermal contact with the first portion of the cold surface of the thermoelectric cooling device, said contact portion having one of the following geometries, absent a contact pressure (P1)
(a) The contact portion rests on two parallel ridges of the cold surface, separating the portion comprised between the two ridges from contact with the cold surface:
(b) The contact portion is arched forming a leaf spring resting on two edges thereof on the cold surface; or
(c) The contact portion is arched away from the cold surface and held in place in cantilever, with one edge in contact with the cold surface.

The heat sink thermally coupled to the hot surface may be selected from one or more of cooling fins, hydraulic cooling, and/or a fan (26).

For liquid dispensing applications, in particular beverages such as beer stored in containers, it is advantageous if the first heat conductive panel comprises a partially cylindrically shaped portion forming a cradle for receiving a first container containing said liquid to be dispensed at a first temperature, T1, below ambient temperature.

The cooling apparatus of the present invention is particularly advantageous over the prior art cooling devices, if it comprises a second heat conductive panel in thermal contact with a second portion of the cold surface over a second contact area, A2, said second heat conductive panel being pressed against the cold surface with a second contact pressure, P2, and further comprises means for varying the second contact area, A2, and/or the second contact pressure, P2. It is preferred that the second heat conductive panel and the means for varying the second contact area, A2, and/or the second contact pressure, P2, are as defined above with respect to the first heat conductive panel and means for varying the first area, A1, or pressure, P1. Preferably the first and second heat conductive panels and the means for varying the first and second contact areas, A1, A2, and/or the first and second contact pressures, P1, P2, are of the same type and geometry.

Cooling apparatus according to claim 7 and 8 or 9, wherein the second heat conductive panel (22) is substantially cylindrically shaped forming a cradle for receiving a second container containing a liquid to be dispensed at a second temperature, T2, below ambient temperature, and comprises means (20A, 20P) permitting the variation of the second contact area, A2, and/or second contact pressure, P2, independently of the first contact area, A1, and/or first contact pressure, P1, using a single thermoelectric cooling device (10). A Cooling apparatus according to the present invention comprising first and second heat conductive panels can advantageously be incorporated in a beverage dispensing appliance, such as a beer or malt based beverage dispensing appliance.

In a preferred embodiment, the cooling apparatus of the present invention comprises a processor capable of selecting and controlling a cooling temperature, T1, T2, upon entry of a code identifying the item to be cooled.

The present invention also concerns a use of area control means allowing the variation of the contact area (A1) between a first heat conductive panel and a cold surface of a thermoelectric device for controlling the cooling temperature of an item in thermal contact with said first heat conductive panel.

Similarly, the present invention also concerns a use of pressure control means allowing the variation of the contact pressure (P1) between a first heat conductive panel and a cold surface (of a thermoelectric device for controlling the cooling temperature of an item in thermal contact with said first heat conductive panel.

### BRIEF DESCRIPTION OF THE FIGURES

For a fuller understanding of the nature of the present invention, reference is made to the following detailed description taken in conjunction with the accompanying drawings in which:

FIG. 1: shows a typical thermoelectric cooling device.

FIG. 2: illustrates two embodiments of how the cooling temperature of an item can be varied (a) by varying the contact area (A1) and (b) by varying the contact pressure (P1) between the contact portion of a heat conductive panel and the cold surface of the thermoelectric cooling device.

FIG. 3: illustrates examples of means for varying the contact area (A1)

FIG. 4: illustrates examples of means for varying the contact pressure (P1).

FIG. 5: shows a beverage dispensing appliance loaded with a single container cooled with a thermoelectric cooling apparatus according to the present invention.

FIG. 6: shows a side view of a beverage dispensing appliance loaded with one or two containers cooled by a single thermoelectric device.

FIG. 7: shows a beverage dispensing appliance loaded with two containers which can be cooled at different temperatures with a single thermoelectric device.

### DETAILED DESCRIPTION OF THE INVENTION

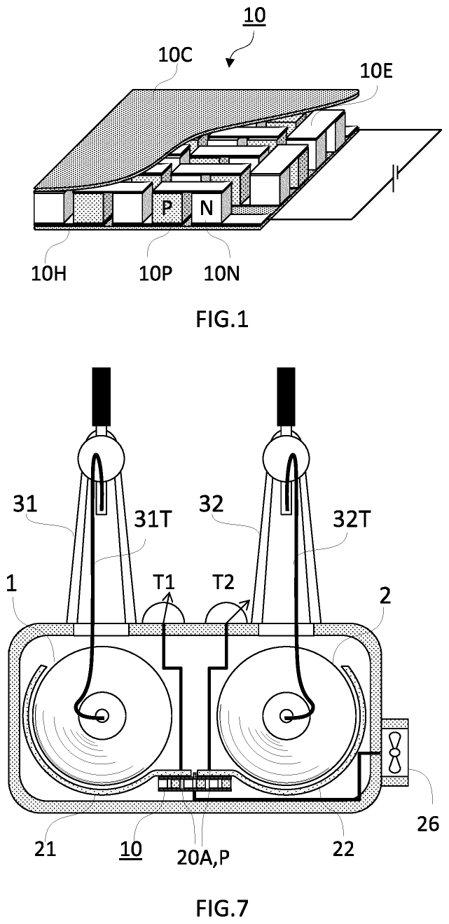

As shown in FIG. 1, a traditional thermoelectric device (10) can be used in the present invention to control the cooling temperature of an item such as a beverage container. It comprises a number of P- and N-doped semiconductor pairs electrically connected to one another by means of electrically conductive bridges (10E). The semiconductors are sandwiched between two non-conductive plates, generally made of ceramic, defining a cold surface (10C) and a hot surface (10H). The thermoelectric device (10) can be put under DC tension to flow current through the circuit formed between the semiconductors and electrically conductive bridges. Heat is retrieved from the cold surface (10C) and transferred to the hot surface (10H) by the so-called Peltier effect.

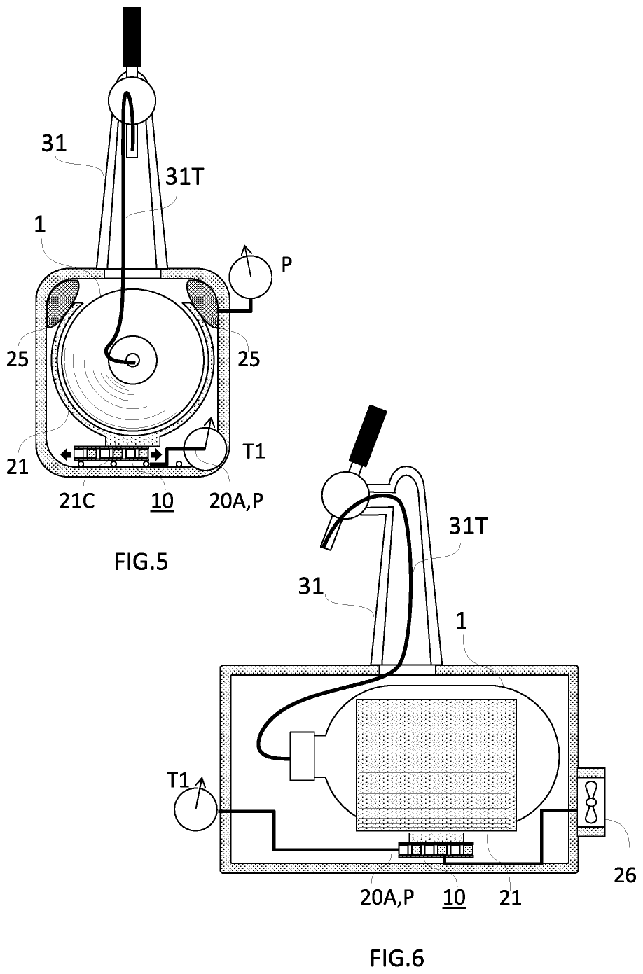

An item such as a container containing a liquid can be cooled by thermally coupling said item to the cold surface (10C) of the thermoelectric device by means of a heat conductive panel (21, 22) as illustrated in FIGS. 5 to 7. The heat conductive panel serves as thermal bridge between the item to be cooled and the cold surface (10C) of the thermoelectric cooling device (10). The heat extracted from a container or from any other item to be cooled, is conducted through the heat conductive panel (21, 22) to the cold surface (10C), whence it is further transferred to the hot surface (10H) of the thermoelectric cooling device and evacuated through a heat sink thermally coupled to said hot surface (10). The heat sink may be in the form of a hydraulic cooling system, cooling fins, or a fan (26) as illustrated in FIGS. 6 and 7. Any form of heat sink known to a person skilled in the art which is suitable for evacuating heat from the hot surface (10H) of the thermoelectric cooling device (10) can be used in the present invention.

The amount of thermal energy extracted from an item to be cooled with a given thermoelectric device (10) fed with a given current intensity depends on the heat conductivity of the heat conductive panel (21, 22) and on the thermal interfaces between the heat conductive panel and, on the one hand, the item (1, 2) to be cooled and, on the other hand, the cold surface (10C) of the thermoelectric device. It is therefore desirable to select a highly conductive material for forming the heat conductive panels (21, 22) such as for example, aluminium, copper, stainless steel, lead, graphite, and for specific applications, silver or gold. Preferred materials for applications in beverage dispensing appliances comprise aluminium and copper.

It is advantageous to enhance the thermal bridge between the item (1, 2) to be cooled and the heat conductive panel (21, 22). The heat conductive panel should therefore preferably match the geometry of the item to be cooled in order to increase the thermal interfacial area between the two. For example, in case of containers (1, 2) containing a beverage to be cooled and comprising a cylindrical body portion, it is advantageous that the heat conductive panels comprise a partially cylindrical geometry of substantially same diameter as the cylindrical portion of the container forming a cosy cradle for receiving the container, as illustrated in FIGS. 5 and 7. As shown in FIG. 5, an inflatable bladder (25) can be provided on the face of the heat conductive panel opposite the face contacting the item to be cooled. By inflating the bladder (25), the heat conductive panel is pressed against the item to be cooled, thus enhancing the thermal contact with the item, and the bladder also acts as a thermal insulator with respect to the surrounding atmosphere, so that more heat is extracted from the item to be cooled.

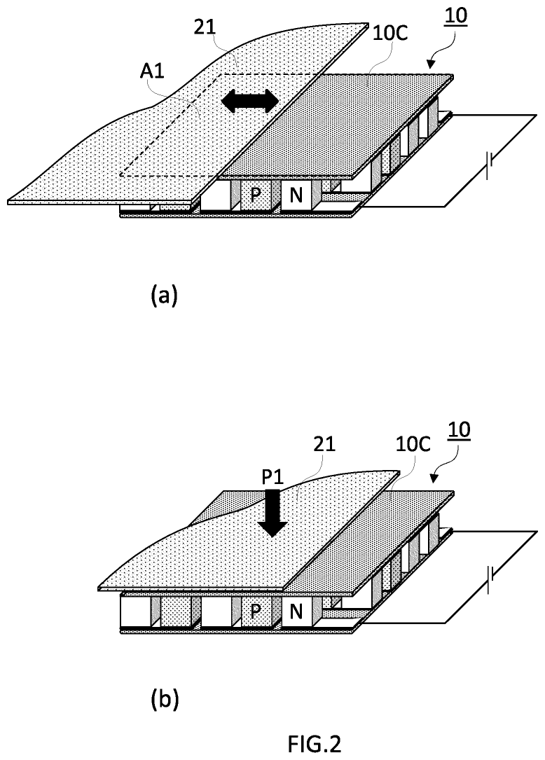

The cooling apparatus of the present invention also comprises control means for controlling the average temperature of the heat conductive panel, and thus the amount of thermal energy extracted by unit time from an item to be cooled. As discussed supra, temperature control in thermoelectric cooling devices is traditionally performed by varying the current intensity fed to a given thermoelectric device. As illustrated in FIG. 2, the gist of the present invention consists in that the temperature control is performed otherwise, namely by varying (a) the contact area (A1, A2) (cf. FIG. 2(a)), or (b) the contact pressure (P1, P2) (cf. FIG. 2(b)), or (c) both contact area and contact pressure, between a heat conductive panel (21, 22) and the cold surface (10C) of said thermoelectric cooling device.

As shown in FIG. 2(a), the contact area (A1; A2) between a heat conductive panel (21, 22) and the cold surface (10C) of a thermoelectric cooling device can be varied by simply translating a contact portion (21C, 22C) of the heat conductive panel with respect to said cold surface (10C). Ideally, the cold surface (10C) and the contact portion (21C, 22C) of the heat conductive panel (21, 22) are both planar, and sliding one surface over the other will vary the contact area in a precise and reproducible manner. Whether it is the contact portion of the heat conductive panel or the cold surface, or both, which is/are actually being moved does not matter and depends on the design requirements of the apparatus. It is, however, preferred in case more than one heat conductive panel (21, 22) are in contact with the cold surface (10C) of one thermoelectric device, that the contact portions of the heat conductive panels are moved over a static cold surface, so that the contact areas, A1,A2, and thus the temperatures of each heat conductive panel can thus be controlled independently from one another.

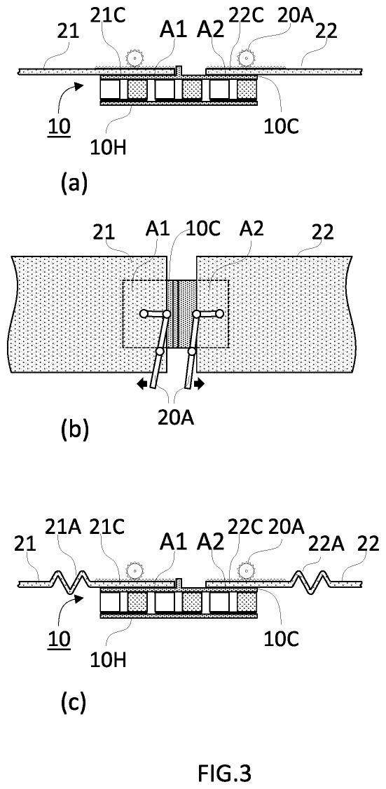

FIG. 3(c) shows a preferred embodiment, wherein the contact portion (21C, 22C) of the heat conductive panel is separated from the portion in contact with the item to be cooled by a a flexible portion (21B, 22B), e.g., having a thinner section, or forming a bellow or corrugated portion, capable of absorbing any translating movements of the contact portion with respect to the cold surface (10C) of the thermoelectric device, without affecting the geometrical configuration and position of the portion of the heat conductive panel in contact with the item to be cooled.

The translation of the contact portion (21, 22C) of a heat conductive panel (21, 22) over the cold surface (10C) of a thermoelectric device can easily be controlled by any means known in the art, both manual and motorized, with the latter being preferably controlled by a processing unit. For example, as shown in FIG. 3(a), the rotation of a cogged wheel engaged in teeth aligned on a surface of the heat conductive panel (21, 22) can be used to accurately control the contact area (A1, A2). Alternatively, any system of hinged lever allowing the translation of the heat conductive panel as illustrated in the top view of FIG. 3(b) can be used instead. A person skilled in the art can devise many alternative solutions for translating a surface over the other in a controlled manner, and any of them which can be implemented in an apparatus as described herein is suitable for the present invention. Regardless of the mechanism used to translate the contact portion of a heat conductive panel over the cold surface (10C) of a thermoelectric cooling device, it can be advantageous to reduce the contact pressure (P1, P2) between said contact portion and the cold surface prior to translating one with respect to the other in order to reduce shear stresses and wear.

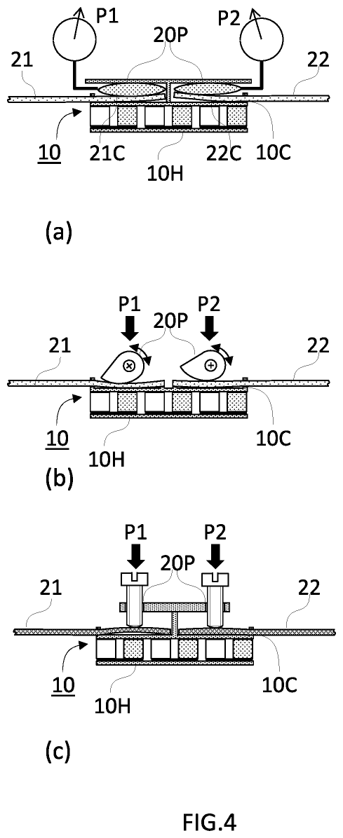

FIG. 4 shows various embodiments of means for varying the contact pressure (P1, P2) applied onto the contact portion (21C, 22C) of a heat conductive panel. For example, as shown in FIG. 4(a), an inflatable bladder can be used to apply a pressure of controlled magnitude onto the contact portion of a heat conductive panel. Inflatable bladders are quite convenient for beverage dispensing appliances, since they are generally provided with a source of pressurized gas to drive the dispensing of the beverage out of the container which can be used to inflate the bladders. Alternative to pneumatic means, mechanical means can be used instead, including for example, as illustrated in FIG. 4(b) cams able to apply a pressure normal to the contact portion of the first heat conductive panel (21) of varying magnitude or, as illustrated in FIG. 4(c), screws which can control the pressure applied onto the contact portion of a heat conductive panel. Electromagnetic means can also be used, such as a solenoid suitable for applying a force onto a contact portion comprising a ferromagnetic material, by feeding current through the solenoid (not shown in the Figures).

In order to yield a more accurate control of the temperature of the heat conductive panels (21, 22), it is preferred that at rest, not the whole surface of the contact portion (21C, 22C) of the heat conductive panel (21, 22) is in contact with the cold surface of the thermoelectric cooler and wherein the application of a contact pressure (P1, P2) substantially normal to the contact portion flexes it, thus establishing a stronger thermal contact with the the cold surface of the thermoelectric cooler. In this embodiment, the application of a contact pressure (P1, P2) allows both to enhance the thermal contact and increase the contact area (A1, A2) between said contact portion and the cold surface (10C). For example, the contact portion may be characterized by one of the following geometries at rest (i.e., absent a contact pressure (P1, P2)):
(a) The contact portion rests on two parallel ridges of the cold surface, separating the portion comprised between the two ridges from contact with the cold surface (10C), as illustrated in FIG. 4(b);
(b) The contact portion is arched forming a leaf spring resting on two edges thereof on the cold surface (10c), as illustrated in FIG. 4(c); or
(c) The contact portion is arched away from the cold surface and held in place in cantilever, with one edge in contact with the cold surface (10C), as illustrated in FIG. 4(a).
   It is clear that such geometries rely on the contact portion (21C, 22C) having a sufficient elasticity (rigidity) in the range of strains applied thereto, to recover their original geometry at rest upon removal of the contact pressure (P1, P2). If the contact portion should be plastically strained, it would not be able to recover its original geometry. In such cases, means should be provided to force the contact portion back into its original geometry. For example, the tip of the screws in FIG. 4(c) could be coupled to the contact portion such that when retrieved (i.e., unscrewed), the contact portion would be pulled away from the cold surface (10C) even if not sufficiently elastic to recover such geometry alone.

The present invention is particularly advantageous if two heat conductive panels (21, 22) are thermally coupled to first and second portions of the cold surface (10C) of a single thermoelectric cooling device (10) as illustrated in FIG. 7, illustrating the cooling of two beverage containers in a beverage dispensing appliance. The different cold temperatures, T1, T2, which two different items must be cooled at can be controlled independently from one another in spite of using a single thermoelectric cooling device by simply varying the contact areas (A1, A2) and/or contact pressures (P1, P2) between the contact portions (21C, 22C) of both heat conductive panels and first and second portions of the cold surface (10C). Each heat conductive panel (21, 22) must be provided with its own means (20A, 20P) for controlling the respective average temperatures of the corresponding heat conductive panels (21, 22), and said means can be any of the ones discussed supra.

For beverage dispensing appliances, this embodiment would be very advantageous in case two different draught beers or wines were to be served at different temperatures, both below room temperature. The heat conductive panels can, as discussed supra and illustrated in FIGS. 5 to 7, be in the form of a partial cylinder wrapping the body of the containers like a cradle. Alternatively or concomitantly, the heat conductive panels (21, 22) can be in thermal contact with the dispensing tubes (31T, 32T) fluidly connecting the interior of the container with atmosphere. The cooling is thus instantaneous and does not require the cooling of the whole container and content thereof. The thermal contact area between the heat conductive panels and the dispensing tubes must be sufficiently large to ensure that the beverage reaches the tap of the tapping column (31, 32) at the desired temperature. For example, the dispensing tube (31T, 32T) may comprise a serpentine in contact with the heat conductive panel thus increasing the thermal contact area (not shown in the Figures).

As discussed above, the control of the temperatures T1, T2, can be handled manually, varying the contact areas (A1, A2) and/or the contact pressures (P1, P2) according to a graduated manometer. They are, however, preferably controlled by a processing unit, suitable for receiving a target temperature, T1, T2, or, alternatively, for reading a bar code on the label of the items to be cooled, in particular a beverage container, such as a keg containing beer or any malt based beverage. The bar code is indicative of the type of beer stored in the container, and the processor has access to a database relating a corresponding serving temperature.

The present invention allows the independent and accurate control of the cooling temperatures of two different items using a single thermoelectric cooling device. The cooling apparatus of the present invention is particularly suitable for cooling containers containing beverages, such as beer, malt based beverages, or cider, contained in containers stored in a chamber of a dispensing appliance.

| REF | DESCRIPTION |
|---|---|
| 1 | first item to be cooled, e.g., first ke |
| 2 | second item to be cooled, e.g., second keg |
| 10 | thermoelectric cooler |
| 21 | first heat conductive panel |
| 22 | second heat conductive panel |
| 25 | inflatable bladder to press the heat conductive panel against item to |
| | be cooled |
| 26 | heat sink or exhaust |
| 31 | first tapping column |
| 32 | second tapping column |
| 10C | cold side of the thermoelectric cooler |
| 10E | electrical conductive bridges |
| 10H | hot side of the thermoelectric cooler |
| 10N | N-doped semiconductor |
| 10P | P-doped semiconductor |
| 20A | area control means for varying the contact area A1, A2 |
| 20P | pressure control means for varying the contact pressure P1, P2 |
| 21A | flexible portion (e.g., bellow) in first heat conductive panel, |
| | absorbing control area variations |
| 21C | contact portion of the first heat conductive panel with the cold |
| | surface |
| 22A | flexible portion (e.g., bellow) in second heat conductive panel, |
| | absorbing control area variations |
| 22C | contact portion of the second heat conductive panel with the cold |
| | surface |
| 31T | dispensing tube of the first container |
| 32T | dispensing tube of the second container |
| A1 | contact area between cold side and contact portion of first heat |
| | conductive panel |
| A2 | contact area between cold side and contact portion of second heat |
| | conductive panel |
| P1 | contact pressure between cold side and contact portion of first heat |
| | conductive panel |
| P2 | contact pressure between cold side and contact portion of second |
| | heat conductive panel |

1. A cooling apparatus comprising:
(a) A thermoelectric cooling device of the Pelletier type, comprising a hot surface and a cold surface,
(b) A heat sink thermally coupled to the hot surface, and
(c) A first heat conductive panel comprising a contact portion in thermal contact with a first portion of the cold surface over a first contact area, A1, said contact portion of the first heat conductive panel being pressed against said portion of the cold surface with a first contact pressure, P1,
(d) Control means for controlling the average temperature of the heat conductive panel;
wherein the control means comprises area control means for varying the first contact area, A1, and/or pressure means for controlling the first contact pressure, P1.

2. The cooling apparatus according to claim 1, wherein the first area control means for varying the first contact area, A1, comprises one of the following:
(a) a rotating knob which rotation drives a translation of the contact portion of the first heat conductive panel along a given direction parallel to and over the first portion of the cold surface, thus varying the first contact area, A1, wherein the knob is preferably connected to a toothed gear gripping teeth aligned on a surface of the contact portion of the first heat conductive panel along said given direction of translation; or
(b) a lever allowing the translation of the contact portion of the first heat conductive panel over the cold surface, by pivoting thereof over a hinge,
and wherein the first heat conductive panel preferably comprises a flexible portion absorbing any translation of the contact portion of the first heat conductive panel to vary the first contact area, A1.

3. The cooling apparatus according to claim 2, wherein before the contact portion of the first heat conductive panel is translated over the first portion of the cold surface of the thermoelectric cooling device, the first contact pressure between the contact portion of the first heat conductive panel and the first portion of the cold surface of the thermoelectric cooling devicer is reduced.

4. The cooling apparatus according to claim 1, wherein the pressure control means for varying the first contact pressure, P1, comprises one of the following:
(a) a cam able to apply a pressure normal to the contact portion of the first heat conductive panel of varying magnitude;
(b) a solenoid able to apply an electromagnetic force to the contact portion of the first heat conductive panel;
(c) a bladder able to apply a pressure normal to the contact portion of the first heat conductive panel of varying magnitude upon inflating by injection of pressurized gas into said bladder; or
(d) a screw able to apply a pressure normal to the contact portion of the first heat conductive panel of varying magnitude.

5. The cooling apparatus according to claim 4, wherein, at rest, not the whole surface of the contact portion of the first heat conductive panel is in contact with the cold surface of the thermoelectric cooler and wherein the application of a contact pressure normal to the contact portion flexes it, thus enhancing thermal contact with the first portion of the cold surface of the thermoelectric cooling device, said contact portion having one of the following geometries, absent a contact pressure:
(a) The contact portion rests on two parallel ridges of the cold surface, separating the portion comprised between the two ridges from contact with the cold surface;
(b) The contact portion is arched forming a leaf spring resting on two edges thereof on the cold surface; or
(c) The contact portion is arched away from the cold surface and held in place in cantilever, with one edge in contact with the cold surface.

6. The cooling apparatus according to claim 1, wherein the heat sink comprises one or more of cooling fins, hydraulic cooling, and/or a fan.

7. The cooling apparatus according to claim 1, wherein the first heat conductive panel comprises a partially cylindrically shaped portion forming a cradle for receiving a first container containing a liquid to be dispensed at a first temperature, T1, below ambient temperature.

8. The cooling apparatus according to claim 1, comprising a second heat conductive panel in thermal contact with a second portion of the cold surface over a second contact area, A2, said second heat conductive panel being pressed against the cold surface with a second contact pressure, P2, and further comprises means for varying the second contact area, A2, and/or the second contact pressure, P2.

9. The cooling apparatus according to claim 8, wherein the second heat conductive panel and the means for varying the second contact area, A2, and/or the second contact pressure, P2, are as defined in any of claims 2 to 6, and preferably the first and second heat conductive panels and the means for varying the first and second contact areas, A1, A2, and/or the first and second contact pressures, P1, P2, are of the same type and geometry.

10. The cooling apparatus according to claim 7, wherein the second heat conductive panel is substantially cylindrically shaped forming a cradle for receiving a second container containing a liquid to be dispensed at a second temperature, T2, below ambient temperature, and comprises means permitting the variation of the second contact area, A2, and/or second contact pressure, P2, independently of the first contact area, A1, and/or first contact pressure, P1, using a single thermoelectric cooling device.

11. The cooling apparatus according to claim 7, incorporated in a beverage dispensing appliance, preferably a beer or malt based beverage dispensing appliance.

12. The cooling apparatus according to claim 1, comprising a processor capable of selecting and controlling a cooling temperature, T1, T2, upon entry of a code identifying the item to be cooled.

13. The use of area control means allowing the variation of the contact area between a first heat conductive panel and a cold surface of a thermoelectric device for controlling the cooling temperature of an item in thermal contact with said first heat conductive panel.

14. The use of pressure control means allowing the variation of the contact pressure between a first heat conductive panel and a cold surface of a thermoelectric device for controlling the cooling temperature of an item in thermal contact with said first heat conductive panel.

15. The cooling apparatus according to claim 2, wherein the pressure control means for varying the first contact pressure, P1, comprises one of the following:
(a) a cam able to apply a pressure normal to the contact portion of the first heat conductive panel of varying magnitude;
(b) a solenoid able to apply an electromagnetic force to the contact portion of the first heat conductive panel;
(c) a bladder able to apply a pressure normal to the contact portion of the first heat conductive panel of varying magnitude upon inflating by injection of pressurized gas into said bladder; or
(d) a screw able to apply a pressure normal to the contact portion of the first heat conductive panel of varying magnitude.

16. The cooling apparatus according to claim 15, wherein, at rest, not the whole surface of the contact portion of the first heat conductive panel is in contact with the cold surface of the thermoelectric cooler and wherein the application of a contact pressure normal to the contact portion flexes it, thus enhancing thermal contact with the first portion of the cold surface of the thermoelectric cooling device, said contact portion having one of the following geometries, absent a contact pressure:
(a) The contact portion rests on two parallel ridges of the cold surface, separating the portion comprised between the two ridges from contact with the cold surface;
(b) The contact portion is arched forming a leaf spring resting on two edges thereof on the cold surface; or
(c) The contact portion is arched away from the cold surface and held in place in cantilever, with one edge in contact with the cold surface.

17. The cooling apparatus according to claim 16, wherein the heat sink comprises one or more of cooling fins, hydraulic cooling, and/or a fan.

18. The cooling apparatus according to claim 3, wherein the pressure control means for varying the first contact pressure, P1, comprises one of the following:
(a) a cam able to apply a pressure normal to the contact portion of the first heat conductive panel of varying magnitude;
(b) a solenoid able to apply an electromagnetic force to the contact portion of the first heat conductive panel;
(c) a bladder able to apply a pressure normal to the contact portion of the first heat conductive panel of varying magnitude upon inflating by injection of pressurized gas into said bladder; or
(d) a screw able to apply a pressure normal to the contact portion of the first heat conductive panel of varying magnitude.

19. The cooling apparatus according to claim 18, wherein, at rest, not the whole surface of the contact portion of the first heat conductive panel is in contact with the cold surface of the thermoelectric cooler and wherein the application of a contact pressure normal to the contact portion flexes it, thus enhancing thermal contact with the first portion of the cold surface of the thermoelectric cooling device, said contact portion having one of the following geometries, absent a contact pressure:
(a) The contact portion rests on two parallel ridges of the cold surface, separating the portion comprised between the two ridges from contact with the cold surface;
(b) The contact portion is arched forming a leaf spring resting on two edges thereof on the cold surface; or
(c) The contact portion is arched away from the cold surface and held in place in cantilever, with one edge in contact with the cold surface.

20. The cooling apparatus according to claim 19, wherein the heat sink comprises one or more of cooling fins, hydraulic cooling, and/or a fan.
